(19) United States
(12) Patent Application Publication
(10) Pub. No.: US 2008/0172448 A1
(43) Pub. Date: Jul. 17, 2008

(54) PACKETIZED BOOT SERVICE BROADCASTING

(75) Inventor: Kevin C. Wonus, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/623,409

(22) Filed: Jan. 16, 2007

(51) Int. Cl. G06F 15/16

(52) U.S. Cl. 709/203

(57) ABSTRACT

A system and method that facilitates and effectuates partitioning, broadcasting and reassembling of a virtual file system on a machine dispersed on a network topology. The system and method includes partitioning virtual file systems into blocks and thereafter continually disseminating the blocks in packets. Additionally the system and method include receiving the packets in an arbitrary sequence, contemporaneously reassembling the blocks contained in the packets to constitute the virtual file system and utilizing the reconstituted virtual file system to boot the machine on which the virtual file system has been reassembled.

### BACKGROUND

The ability to boot across networks is not new. For instance, bootp (e.g., the Bootstrap Protocol) uses an asynchronous network protocol (e.g., the User Datagram Protocol (UDP)) to enable “diskless workstations and/or clients” to obtain an IP address prior to loading any advanced operating system. Historically, bootp has been employed for Unix-like diskless workstations and by corporations to roll out pre-configured client installation to newly purchased Personal Computers. Originally, bootp required the use of a boot floppy disk to establish an initial network connection; however subsequent developments have embedded bootp functionality into the BIOS of some network cards (e.g., the 3c905c Fast EtherLink XL PCI Network Interface Card) and typically in many modern motherboards that permit direct network booting.

Bootp however is not optimized to minimize bandwidth on the network; bootp clients are synchronized to an identified bootp server, each bootp client receiving its own individual stream to boot the Operating System (OS) across a network from the identified bootp server. Thus, bootp is inefficient with respect to network bandwidth and the underlying multicasts are only consumed exclusively by a single bootp client as the client and server effectively enter into a peer-to-peer handshake.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in one aspect provides a system and method that allows all clients dispersed over a network topology to boot from a virtual file-system wherein network throughput is optimized as multiple clients can simultaneously consume identical broadcast packets. The boot server broadcasts the file-system as a series of uniquely identified binary packets in a continuous loop. For example, if a file system has been packetized into ten packets, then the boot server will continuously and repeatedly broadcast these ten packets in sequence. Boot clients can thus listen in on broadcasts that are in progress and can immediately commence receiving and assembling the uniquely identified binary packets in mid-sequence to reconstitute the file-system. The boot client reconstructs the file system by ordering the packets as they were at the broadcast origin. Additionally and/or alternatively, the boot server can maintain a counter that indicates the number of clients that express an interest in receiving the packetized file system (e.g., interested listeners), thus the boot server can continue broadcasting the packetized file system until the number of interested listeners reaches zero.

In a further aspect the claimed subject matter provides a system and method that partitions a file system (e.g., a virtual file-system) into discrete packets, sequentially numbers the packets created while contemporaneously keeping track of the total number of packets created, associates unique identifiers to the totality of packets and distributes the unique identifiers to each of the discrete packets to each packet created. The system and method can partition the file system on an ad-hoc basis, on demand and/or the file system can be pre-partitioned awaiting subsequent broadcast.

In yet another aspect the claimed subject matter provides a system and method that transmits a boot service request that can be satisfied by one or more boot/broadcast server, listens for packets comprising a virtual file system emanating from the boot server, accepts the packets regardless of the fact that the packet numbers commence mid-sequence, and immediately commences reconstituting the packets starting with the first received packet. For instance, if the total number of packets to be broadcast is 25, and the claimed subject matter commences listening while the broadcast server is distributing packet 23, the claimed subject matter can commence constituting the file system with packets 23-25, and then packets 1-22, until totality of the packets has been received, at which point the claimed subject matter can transmit a desist indication that provides indication to the boot/broadcast server that all packets have been received.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system for packetizing and disseminating packetized file systems in accordance with the claimed subject matter.

FIG. 2 provides a more detail depiction of a broadcast server for packetizing and disseminating file systems in accordance with one aspect of the claimed subject matter.

FIG. 3 provides more detailed illustration of a broadcast client that requests and/or automatically receives packetized file systems from a broadcast server in accordance with another aspect of the subject matter as claimed.

FIG. 4 depicts an illustrative transportation packet 400 employed to transmit a packetized virtual file system in accordance with an aspect of the claimed subject matter.

FIG. 5 depicts a system employed to effectuate and facilitate partitioning/packetizing and distribution of packetized file systems over a network topology in accordance with one aspect of the claimed subject matter.

FIG. 6 depicts a flow diagram of an illustrative methodology that facilitates and effectuates partitioning/packetizing and distribution of packetized virtual file systems from the perspective of a broadcast server in accordance with one aspect of the claimed subject matter.

FIG. 7 illustrates a flow diagram methodology that facilitates and effectuates partitioning/packetizing of virtual file systems in accordance with an aspect of the subject matter as claimed.

FIG. 8 illustrates a flow diagram methodology that facilitates and effectuates requesting, receiving, and assembling partitioned/packetized virtual file systems to cause a processing unit to boot in accordance with an aspect of the claimed subject matter.

FIG. 9 depicts a flow diagram of an illustrative methodology that facilitates and effectuates reconstituting partitioned/packetized virtual file systems in accordance with one aspect of the claimed subject matter.

FIG. 10 illustrates a block diagram of a computer operable to execute the disclosed packetized boot service broadcasting architecture.

FIG. 11 illustrates a schematic block diagram of an exemplary computing environment for processing the packetized boot service broadcasting architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

The claimed subject matter relates to a deployment/boot service implemented by partitioning or packetizing a file-system (e.g., a virtual file system) in Binary Large Objects (e.g., BLOBs) so that the packetized file-system can be broadcast to network clients without the need for network clients to synchronize with the boot server and/or peer clients.

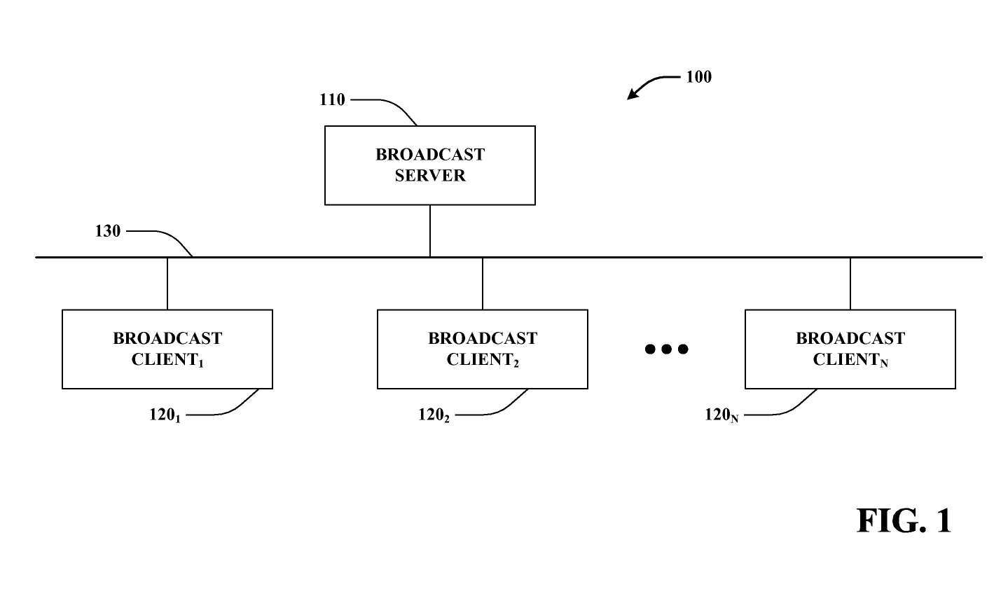

FIG. 1 illustrates a system 100 for packetizing and disseminating packetized file systems that includes a network segment 130 (e.g. wireless and/or wireless) comprising a broadcast server 110 that has stored thereon file systems and that, on request and/or continuously, partitions the persisted file systems into blocks that can be placed into packets that can be broadcast over the network segment 130 to a first broadcast client 120, through to an Nth broadcast client 120_{N}, N being an integer greater than or equal to one. The first broadcast client 120₁ through the Nth broadcast client 120_{N} can be referred to collectively as broadcast client 120.

Broadcast server 110 can operate in one of two modes. Broadcast server 110 can passively await a boot request from broadcast client 120, at which time broadcast server 110 can dynamically and automatically commence packetizing one or more persisted file systems and broadcasting the packetized file system over network 130 to broadcast client 120. Alternatively and/or additionally, broadcast server 110 can continuously disseminate the packetized file system over network 130 so that any and all broadcast clients 120 can retrieve the file system packets from network 130 without the need for the broadcast server 110 to receive indication from a broadcast client 120 that the broadcast client 120 requires a packetized file system to be distributed.

Broadcast client 120, typically a machine such as a computing and/or processing device (e.g., Personal Digital Assistants (PDAs), Programmable Logic Controllers (PLCs), industrial and/or consumer electrical/electronic devices, portable computers, notebook computers, handheld devices, etc.), can for example, through a microkernel associated with BIOS resident on broadcast client 120, send a request to broadcast server 110 to commence distributing a packetized file system. Alternatively and/or additionally, broadcast client 120 can, upon power up, immediately commence listening for packets continuously being broadcast by broadcast server 110 and can immediately pick up such packets and automatically start assembling the received packet into a reconstituted file system from which the boot client 120 can employ to complete the boot process and become fully operational (e.g., allow one or more uses to effectuate operation of the device).

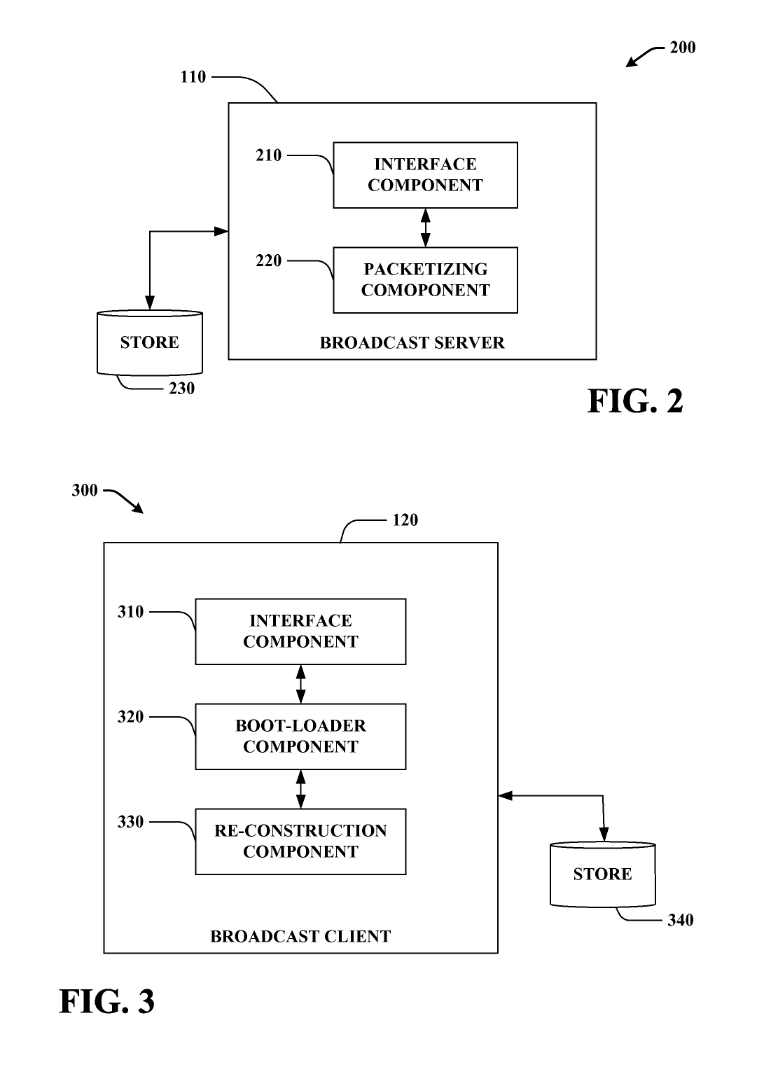

FIG. 2 provides a more detail depiction 200 of broadcast server 110 that can include interface component 210 that is in operative communication with wired and/or wireless network segment 130 (see FIG. 1). Interface component 210 can receive from, and transmit data to, broadcast clients 120. Typically interface component 210 can for example, receive indications from broadcast clients 120 of the need for a particular packetized file system, that the packetized file system was received in its entirety and/or is no longer required to be broadcast for a particular broadcast client 120, and/or that a particular broadcast client 120 requires a different packetized file system is required and needs to be broadcast, and the like. Additionally, interface component 210 also will generally undertake to broadcast packetized file system, either continuously, periodically, or until such time that none of the broadcast clients 120 require a particular packetized file system.

Broadcast server 110 further can include packetizing component 220 that retrieves a file system from store 230, partitions the file system into one or more chunks, and incorporates the chunks into one or more packets for subsequent distribution to, and reassembly by, one or more broadcast client 120 (see FIG. 1).

Packetizing component 220 while partitioning the file system retrieved from store 230 makes a note of the total number of partitions created and the total size of the file system that is being partitioned, for instance. Additionally, packetizing component 220 can retrieve a Media Access Control (MAC) address associated with broadcast server 110 (or any other data associated with broadcast server 110 that can be employed to distinctively identify subsequently distributed packets as emanating from broadcast server 110), and/or can generate a unique identifier to associate with the file system being partitioned. The MAC address and/or other distinctive identification information associated with broadcast server 110, the unique identifier, if generated, together with the total number of partitions created, the total size of the file system at issue, the chunk number of the particular partition of the file system (e.g., this is chunk 5 of 325 total chunks) and cyclical redundancy check information can be incorporated into, and/or distributed between, the packet header and packet trailer for future use by broadcast clients 120. The packet header and/or trailer information can be used by broadcast clients 120 to identify the appropriateness of the file system being reconstructed (e.g., if there are two or more other broadcast servers dispersed on network 130, each broadcasting disparate packetized file systems, broadcast client 120 will need to ensure that packets being accepted are appropriate to their needs) and for the purposes of correctly re-assembling the packetized file system.

Store 230 can include one or more file systems that can be employed by one or more disparate broadcast client 120 (see FIG. 1). More particularly, store 230 can have persisted thereon many disparate file systems. For example, store 230 can contain a file system specifically for booting a Personal Computer with a thin version of an operating system that allows an individual accessing the Personal Computer to utilize a word processing package. Alternatively and/or additionally, store 230 can contain file systems specifically directed to factory automation wherein multiple unique file systems with different functionalities can contemporaneously be downloaded to each of the broadcast clients 120, depending on the particular function that individual broadcast clients 120 are to undertake within the scheme of the factory automation, for example. Accordingly, store 230 can comprise a single disk, a disk array, a cluster of disk arrays, a database (with associated database management functionalities), and the like. Additionally, store 230 can be distributed over a Wide Area Network (WAN), a Storage Area Network (SAN), and/or a Local Area Network (LAN). Further, store 230 can be associated with one or more disparate broadcast server through one or more protocol for accessing and sharing file systems across a computer network (e.g., Network File Sharing (NFS), Server Message Block (SMB), Common Internet File System (CIFS), Andrew File System (AFS), etc.).

FIG. 3 illustrates system 300, an individual broadcast client 120 that can dynamically request and/or automatically receive packetized file systems from broadcast server 110. Broadcast client 120 can include interface component 310 that can be in continuous wired and wireless operative communication with network 130 (see FIG. 1). Additionally, broadcast client 120 can include bootloader component 320 that, at power up initiates installation of system and application software on broadcast client 120 in order for broadcast client 120 to become operationally functional. Bootloader component 320 can be a single stage boot loader and/or a multiple-stage boot loader wherein several small programs included as part of bootloader component 320 summon each other, until the last of program loads the operating system and any other software necessary to effectuate functional operation of boot client 120.

Bootloader component 320 on power up of broadcast client 120 can send indication through interface component 310 to broadcast server 110 that broadcast client 120 requires a particular boot file system to commence effective operations. Alternatively and/or additionally, bootloader component 320 can instigate interface component 210 to listen for and acquire packets disseminated as a constantly looping and unending broadcast stream by broadcast server 110 containing a relevant and necessary boot file system.

When interface component 310 retrieves packets containing relevant file system data, the interface component 310 can convey the packets to re-construction component 330 that utilizes information stored in the packet headers and the blocks stored in the payload of the packet to reconstruct the transmitted file system so that broadcast client 120 can start effective operations. The re-construction component 330, when assembling the packets arriving as a stream and containing the packetized file system, can utilize an associated store 340 to store and re-constitute the packetized file system. Alternatively and/or additionally, re-construction component 330 can employ one or more associated memories (not shown) to store and re-construct the packetized file system for subsequent use to bring broadcast client 120 into operation for its intended purpose.

It should be noted and appreciated that broadcast client 120, once it has retrieved and re-assembled the partitioned/packetized file system, and has appropriately configured and provisioned itself, that it too can become a broadcast server and can undertake the functionality of broadcast server 110 as detailed above.

While FIGS. 2-3 provide block diagrams illustrating components for systems 200-300, it is to be appreciated that systems 200-300 and all components represented therein can be implemented individually and/or collectively as one or more computer components, as that term is defined herein. Thus, it is to be appreciated that computer executable components operable to implement systems 200-300 and components illustrated therein can be stored on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the disclosed subject matter.

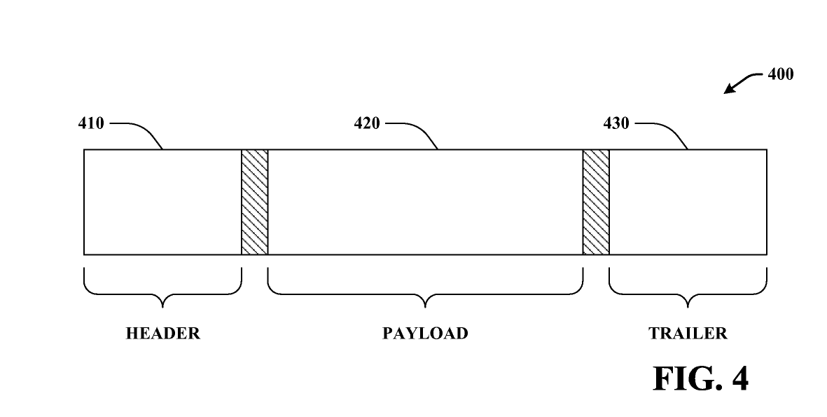

FIG. 4 depicts an illustrative packet 400 that can be employed to transport a packetized file system throughout a network topology and subsequently use by one or more industrial and/or consumer processing devices (e.g., computer servers, notebook computers, laptop computers, handheld computing/processing devices, industrial automation devices, industrial non-destructive testing devices, digital video recording devices, Smart phones, cell phones, and the like). Illustrative packet 400 can include a header 410 and trailer 430 that exclusively and/or in combination can for instance contain pertinent information for identifying packet 400 as containing packetized file system data in payload 420. Additionally, header 410 and trailer 430 individually and/or in combination can further include, for example, information that uniquely identifies the packet as emanating from an individual broadcast server, data that indicates the type of file system (e.g., a file system build number, version of an operating system, patch version number, applications incorporated into the file system, etc.) being transport in payload 420, data pertaining to the requirements needed by a putative broadcast client to be able to utilize/install the file system encapsulated in packet payload 420, information relating to the total number of packets that are necessary to reconstruct the file system contained in payload 420, information with regard to which respective portion of the file system to which the instant packet relates to (e.g., a sequence number), the total size of the file system (e.g. the size that the file system should be when the broadcast client reconstitutes it), and/or a checksum that can be utilized to ensure packet 400 and payload 420 integrity.

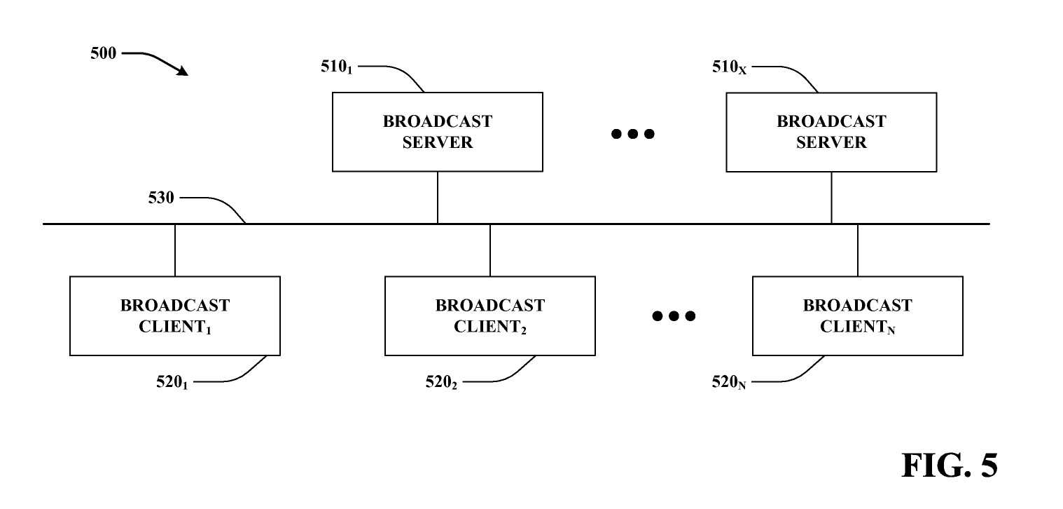

FIG. 5 provides illustration of a system 500 that can be employed to effectuate and facilitate partitioning/packetizing and distribution of packetized file systems over a wired and/or wireless network topology. System 500 can include a first broadcast server 510₁ through to an Xth broadcast server 510_{X}, X being an integer greater than or equal to one. Broadcast server 510₁ through to the Xth broadcast server 510_{X} can be associated with, and distribute one or more identical partitioned and packetized virtual file systems and file system builds persisted on storage means associated with one or more of the broadcast server 510₁ through to broadcast server 510_{X}. Additionally and/or alternatively, broadcast server 510₁ through to broadcast server 510_{X} can be associated with, and disseminate disparate file systems, file system builds and/or applications that have been stored on persisting means coupled with broadcast server 510₁ through to broadcast server 510_{X}. Broadcast server 510₁ through to the Xth broadcast server 510_{X} can continuously broadcast packetized versions of the file systems, file system builds, and/or applications associated therewith over network topology 530. Alternatively and/or additionally, broadcast server 510₁ through to the Xth broadcast server 510_{X} can passively await an indication from first broadcast client 520₁ through to an Nth broadcast client 520_{N} (collectively referred to as broadcast client 520) that one or more of the boot client 520 requires a particular packetized/partitioned file system, file system build and/or individual application.

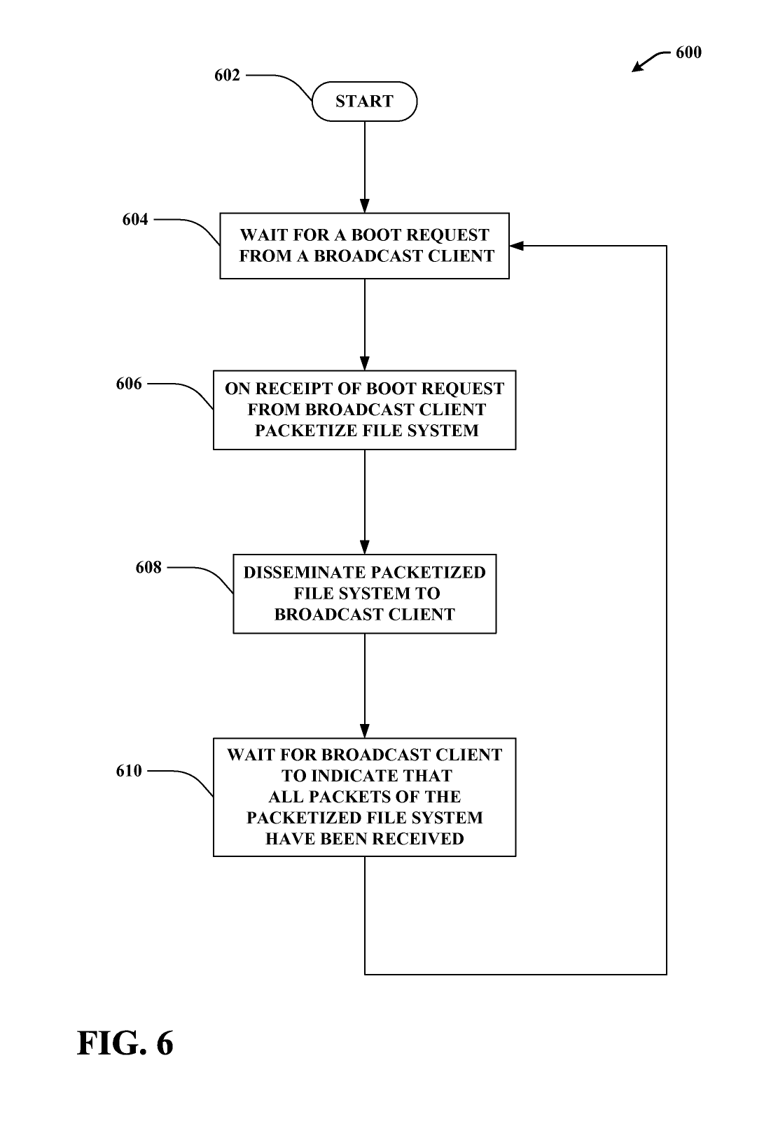

In view of the exemplary systems shown and described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 6 depicts a flow diagram of an illustrative methodology 600 that facilitates and effectuates partitioning/packetizing and distribution of packetized virtual file systems in one aspect from the perspective of a broadcast server. The method commences at 602 wherein various processor initializations tasks and background activities are performed. After these tasks have been performed the method proceeds to 604 where the broadcast server waits for a boot request to be received from a broadcast client. When a boot request is received the method proceeds to 606 where the broadcast server notes the indication of interest from the broadcast client (e.g., increments an indication of interest counter), commences partitioning the virtual file system and placing the partitioned portions into the payload portion of one or more packets. Further at 606 the broadcast server notes and incorporates into the packet header and/or trailer the total size of the virtual file system, the number of partitions and commensurately the number of packets that will be distributed and that will contain the partitioned virtual file system, the relative sequence number of the instant partition/packet, and other pertinent information associated with the broadcast server disseminating the virtual file system. The method then progresses to 608 whereupon the broadcast server commences broadcasting in packet form the virtual file system. The broadcast server can continually (e.g. repeatedly with periodic intermissions) and continuously (e.g., unceasingly without interruption; in an unbroken stream) broadcast the packetized and sequenced virtual file system for utilization by any and all broadcast clients until such time that the broadcast clients indicate that all packets of the packetized file system have been received and that the packetized virtual file system need not be disseminated any further (e.g., the indication of interest counter equals zero) at 610 whereupon the method loops back to 604.

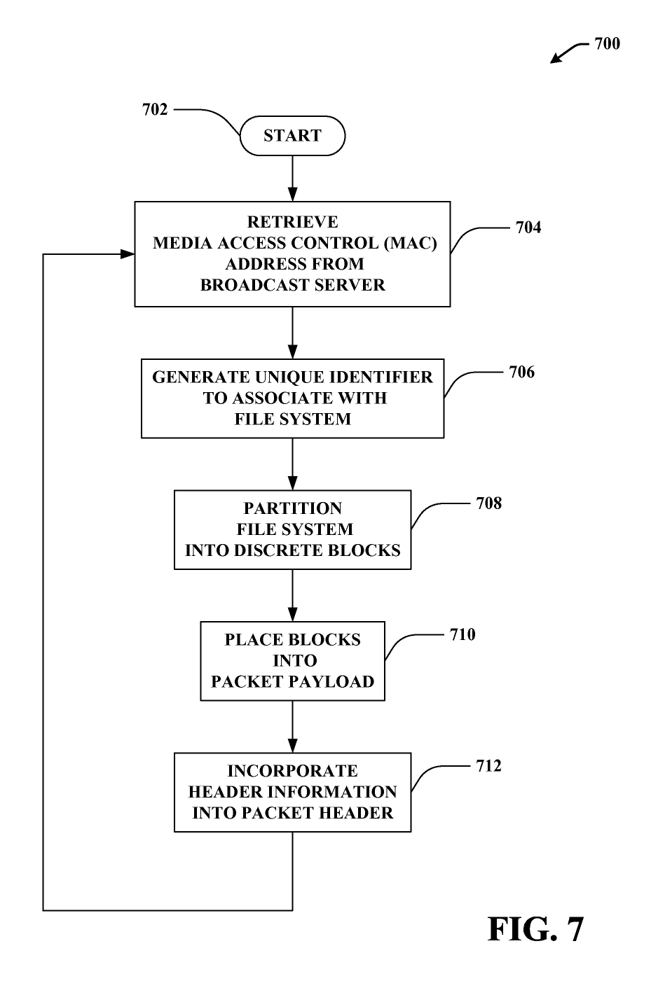

FIG. 7 illustrates a flow diagram methodology 700 that facilitates and effectuates partitioning/packetizing of virtual file systems. Though not so limited, method 700 typically can be executed on a broadcast server to partition and/or partition one or more virtual file systems persisted on storage media associated with the broadcast server. The method commences at 702 whereupon various sundry processor initialization tasks and background activities are performed. On completion of the initialization tasks and background activities the method proceeds to 704 where the method probes the broadcast server from relevant identifying information (e.g. Media Access Control (MAC) address, IP address, processor serial number, etc.) that can be employed to uniquely identify packets as being broadcast from a particular broadcast server. Having obtained the requisite identifying information from the broadcast server, the method progresses to 706 where a unique identifier is generated to be associated with the virtual file system that is to be partition. The method subsequently proceeds to 708 at which point the virtual file system is partition into discrete blocks which at 710 are bundled into a packet to comprise the payload of the packet. At 712 the relevant identifying information, the previously generated identifier and any other pertinent identifying information can be placed in the packet header, at which point the method returns to 704.

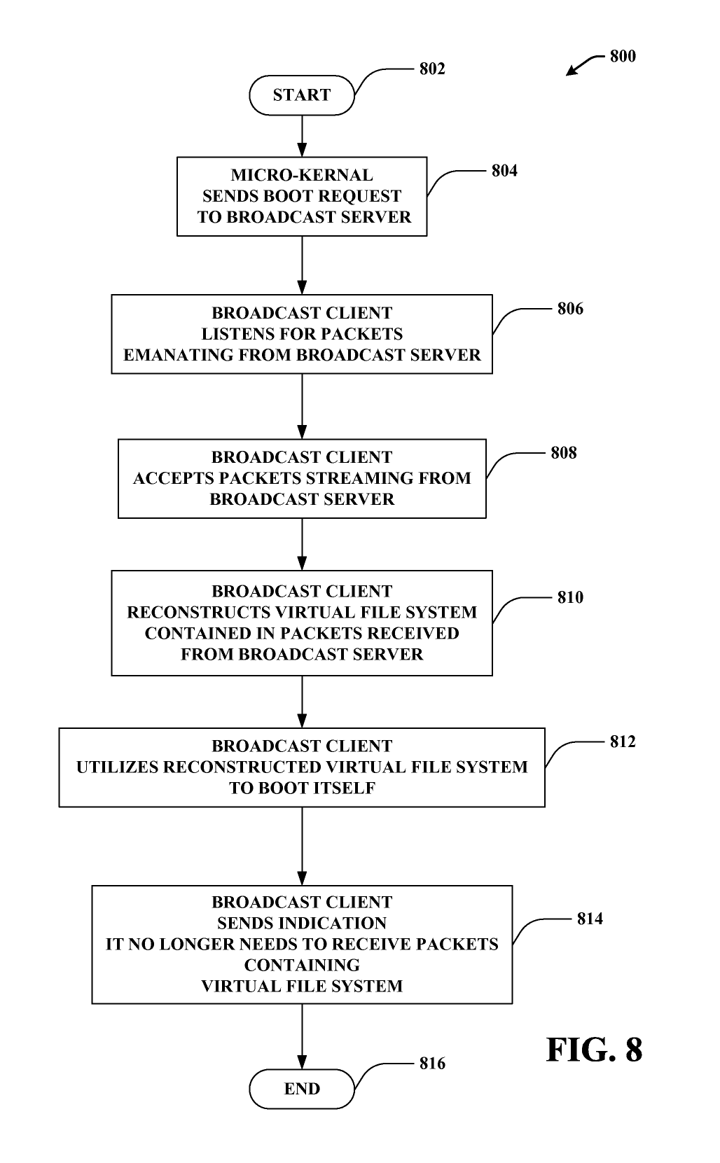

FIG. 8 illustrates a flow diagram methodology 800 that facilitates and effectuates requesting, receiving, and assembling partitioned/packetized virtual file systems to cause a processing unit to boot. Method 800 commences at 802 where preliminary processor initializations and various sundry background tasks are undertaken. Once the preliminary tasks have completed, the method progresses to 804 where a microkernel that can be associated with processor BIOS sends a boot request to a broadcast server, either to provide indication that the broadcast client is interested in receiving a pertinent packetized virtual file system, or alternatively to indicate to the broadcast server that it should commence distributing a particular virtual file system. The method then proceeds to 806 where the broadcast client listens for packets emanating from a broadcast server containing a packetized virtual file system that it can employ. Once the broadcast client locates a stream of packets containing a relevant packetized virtual file system, the method progresses to 808 whereupon the broadcast client commences accepting the packets (regardless of whether the stream of packets is picked up midstream (e.g. the first packet retrieved from the network by the broadcast client is not necessarily the initial packet of the virtual file system as distributed by the broadcast server)) containing the pertinent virtual file system. At 810 the broadcast client commences reconstructing the virtual file system contained in the received packets and as disseminated by the broadcast server (e.g., the packets containing the virtual file system can be received in a random order, an arbitrary order, a sequenced order commencing from an initial packet and ending in a last packet, and/or a sequenced order wherein the first packet received denotes a mid-order sequence, etc.). Once the broadcast client has completed reconstructing the virtual file system at 810, the broadcast client employs the virtual file system to boot itself into full operational and functional readiness (e.g., individual can utilized the broadcast client to undertake one or more user directed tasks). At 814 the broadcast client having brought itself into operational and functional readiness sends an indication that it is no longer needs to receive packets containing the virtual file system and which point the methodology proceed to 816 at which point the method terminates.

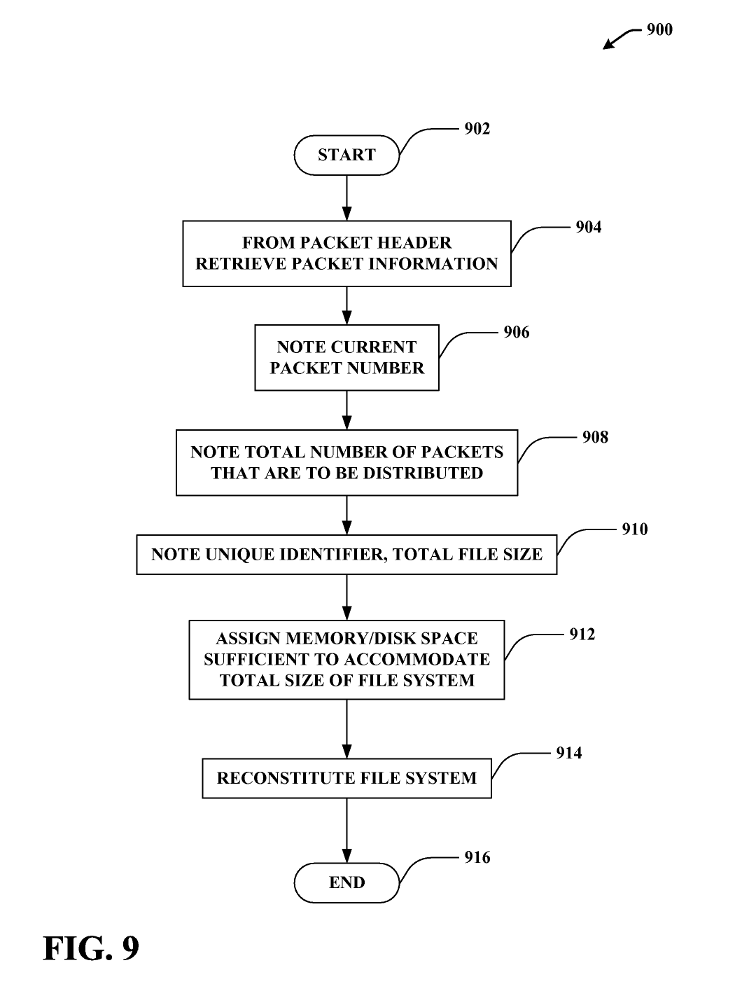

FIG. 9 depicts a flow diagram of an illustrative methodology 900 that facilitates and effectuates reconstituting partitioned/packetized virtual file systems in accordance with one aspect of the claimed subject matter. The method commences at 902 wherein various initializations and background tasks are undertaken. At 904 the method extracts from the packet header sundry information necessary for the reconstruction of the virtual file system from received packets. At 906 the method notes the current packet number indicated from information stored in the packet header. At 908 the method retrieves from the packet header and/or trailer and notes the total number of packets that the particular distribution purportedly contains, and at 910 the method extracts from the packet header and/or trailer the total file size that the packetized virtual file system purports to be, and one or more unique identifier and other disparate identification information that provides indication as to which of the many broadcast servers dispersed over a network topology the current packetized file system emanates. At 912 the methodology, based at least in part on the extracted total file size, allocates sufficient memory and/or disk space to be able to construct and persist the re-constituted virtual file system. At 914 the methodology reconstitutes the virtual file system from the received packets. At 916 the methodology terminates.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g. methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

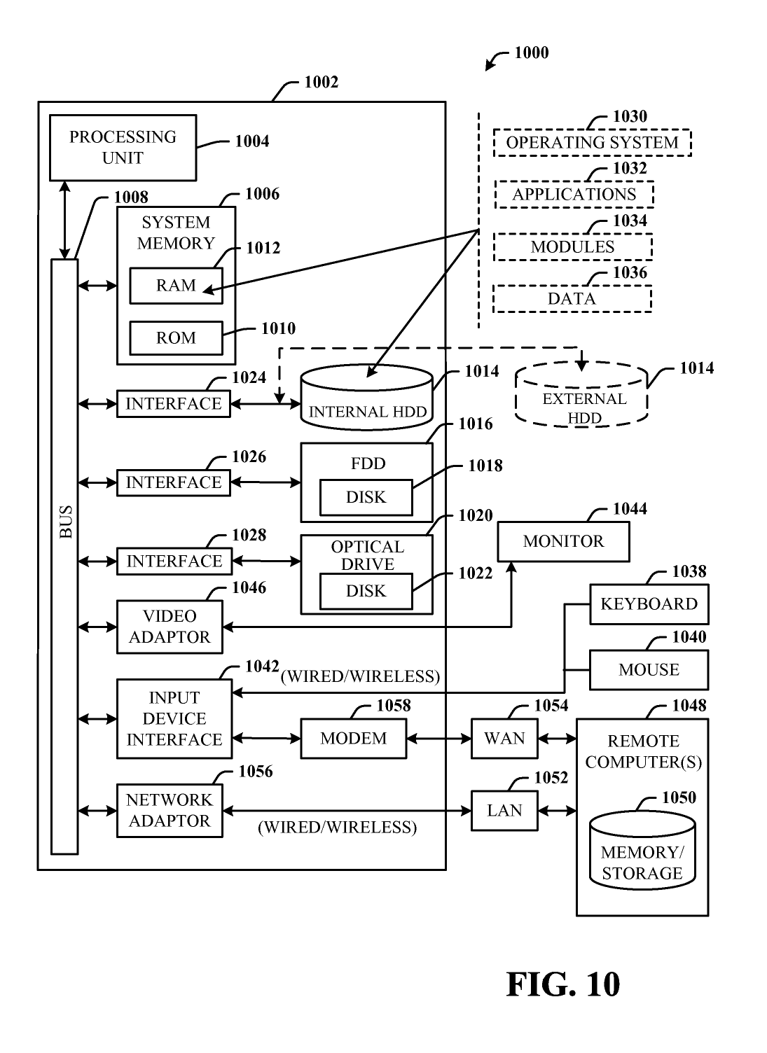

Referring now to FIG. 10, there is illustrated a block diagram of a computer operable to execute the disclosed system(s). In order to provide additional context for various aspects thereof, FIG. 10 and the following discussion are intended to provide a brief, general description of a suitable computing environment 1000 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

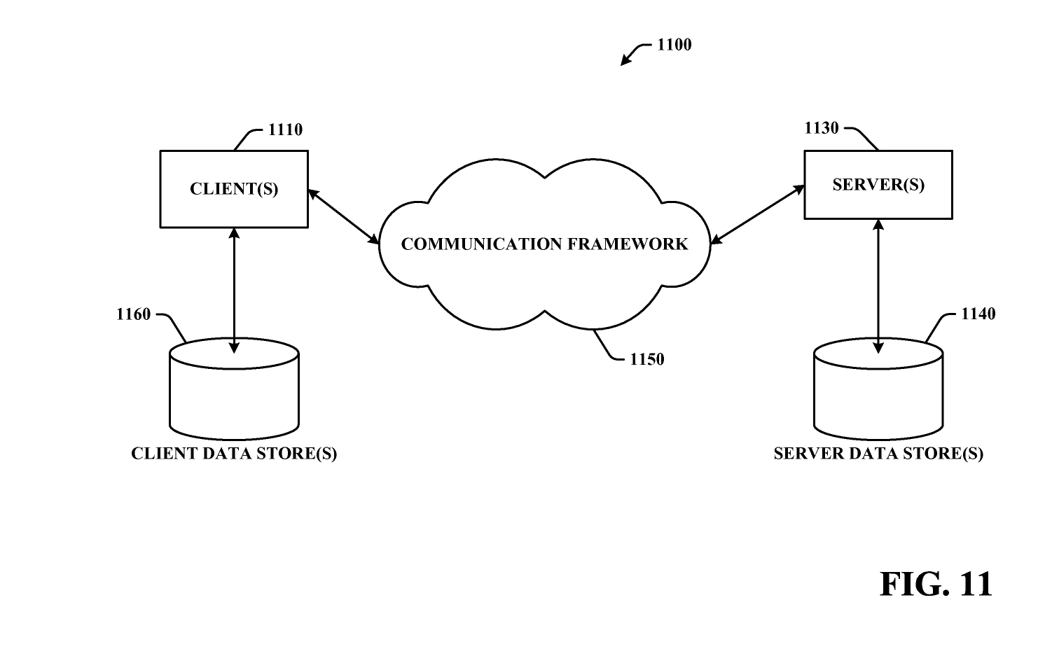

Referring now to FIG. 11, there is illustrated a schematic block diagram of an exemplary computing environment 1100 for processing the packetized boot service broadcasting architecture in accordance with another aspect. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that partitions, distributes and reassembles a virtual file system, comprising:
a server that partitions the virtual file system into blocks and continually distributes the blocks in one or more packets; and
a client that receives the one or more packets in mid sequence of the distribution of the one or more packets, the client contemporaneously reassembles blocks contained in the one or more packets immediately on receipt of the one or more packets to constitute the virtual file system.

2. The system of claim 1, the server continuously distributes the one or more packets.

3. The system of claim 1, the server distributes the one or more packets in an arbitrary order.

4. The system of claim 1, the server disseminates the one or more packets in an ordered sequence.

5. The system of claim 1, the client employs information associated with the one or more packets to allocate space on a persisting device sufficient to contain the constituted virtual file system.

6. The system of claim 1, information associated with the server is included with the one or more packets containing the virtual file system.

7. The system of claim 6, the information associated with the server includes a Media Access Control (MAC) address.

8. The system of claim 1, the one or more packets contain information associated with a total size of the virtual file system.

9. The system of claim 1, the one or more packets contain information related to a total number of blocks into which the virtual file systems has been partitioned.

10. The system of claim 1, the server receives an indication that the client requires the virtual file system.

11. The system of claim 10, the indication generated by a microkernel associated with the client.

12. The system of claim 1, the constituted file system employed on the client to boot the client.

13. The system of claim 1, the virtual file system includes one or more of operating system software and application software.

14. The system of claim 1, the virtual file system associated with disparate operating system and application software builds and versions.

15. The system of claim 1, the virtual file system customized to execute on one or more specialized processing devices.

16. The system of claim 15, the one or more specialized processing devices include one or more of a Smart phone, an industrial automation device, a digital video recording device, a Personal Digital Assistant (PDA), and a Personal Computing (PC) device.

17. A method effectuated on a machine for partitioning, disseminating and reassembling a virtual file system, comprising:
partitioning the virtual file system into a block;
ensconcing the block into a packet;
broadcasting the packet over a network topology in an arbitrary sequence;
receiving the packet in the arbitrary sequence; and
contemporaneously reconstructing the virtual file system from the packet as received in the arbitrary sequence.

18. The method of claim 17, the broadcasting includes continuously distributing the packet over the network topology.

19. The method of claim 17, the broadcasting includes continually disseminating the packet over the network topology.

20. A system that partitions, broadcasts and constructs a virtual file system, comprising:
means for partitioning the virtual file system into a block;
means for including the blocks into packets;
means for transmitting the packets over a network;
means for receiving the packets in a random sequence and reconstructing the virtual file system on a persisting means associated with the means for receiving, the reconstructed virtual file system employed to boot the means for receiving.
